(19) United States
(12) Patent Application Publication
(10) Pub. No.: US 2014/0150049 A1
(43) Pub. Date: May 29, 2014

(54) METHOD AND APPARATUS FOR CONTROLLING MANAGEMENT OF MOBILE DEVICE USING SECURITY EVENT

(71) Applicant: Electronics and Telecommunications Research Institute, (US)

(72) Inventors: Hyeok Chan KWON, Daejeon (KR); Gaeil AN, Daejeon (KR); Sokjoon LEE, Daejeon (KR); Byung Ho CHUNG, Daejeon (KR); Sin Hyo KIM, Daejeon (KR)

(73) Assignee: Electronics and Telecommunications Research Institute, Daejeon (KR)

(21) Appl. No.: 13/735,594

(22) Filed: Jan. 7, 2013

(30) Foreign Application Priority Data
Nov. 26, 2012 (KR) 10-2012-0134492

(51) Int. Cl. H04L 29/06

(52) U.S. Cl. CPC H04L 63/20
USPC 726/1

(57) ABSTRACT

A method controls the management of a mobile device using a security event. The method includes acquiring, by a wireless intrusion prevention server, security threat information by monitoring RF signals generated from an access point (AP) and the mobile device, transmitting the security threat information to a mobile device management server, and executing, by the mobile device management server, a device management policy for the mobile device based on the security threat information.

### RELATED APPLICATIONS(S)

This application claims the benefit of Korean Patent Application No. 10-2012-0134492, filed on Nov. 26, 2012, which is hereby incorporated by references as if fully set forth herein.

### FIELD OF THE INVENTION

The present invention relates to a method for controlling management of a mobile device, and more particularly, to an apparatus and method for controlling management of mobile devices using security events, which is suitable to effectively perform wireless local area network (WLAN) service control on the mobile devices through the information sharing between a mobile device management server and a wireless intrusion prevention server.

### BACKGROUND OF THE INVENTION

As it is well known, a wireless intrusion prevention system is a system for preventing intrusion in a wireless LAN environment. This system detects and blocks various security threats such as a DoS attack or an unauthorized Rogue access point (AP) in a management domain.

The wireless intrusion prevention system may include a wireless intrusion prevention sensor for collecting and analyzing an RF signal of a wireless LAN and performing counterblow to block intrusion and a wireless intrusion prevention server for comprehensively managing the security of a wireless LAN infra. Herein, the wireless intrusion prevention sensor may include a stand-alone product or an all-in-one product that is embedded in an AP.

A mobile device management (MDM) server is a system capable of remotely managing a mobile device at anytime and anywhere if the mobile device is powered on, using a portable device over the air (OTA) technology. The MDM server may provide various functions such as device management (e.g., automatically updating a firmware of the mobile device), registration for use and tracking management, registration/authentication/recovery for the mobile device, withdrawal of the use of the mobile device when the mobile device is lost or stolen (e.g., data deletion/lock of the mobile device), software distribution through the MDM server, remote diagnosis and after service (AS) for the mobile device, and so on.

In order to provide a user with the above mobile device management service, a mobile device should include an MDM agent. Since, however, information of the mobile device detectable by the MDM agent is limited, there is required a technology of securing additional information so as to more effectively perform an MDM function.

In general, device identification (ID) of a mobile device (i.e., mobile terminal) is verified by confirming a medium access control (MAC) address of the mobile device.

However, when the mobile device falsifies (or forges) the MAC address through MAC spoofing, a MDM server may not detect the MAC falsification. As a result, a malicious spoofing attack or illegal release of personal information (e.g., ID, password, financial information, and so on) may occur.

### SUMMARY OF THE INVENTION

In accordance with an aspect of the present invention, there is provided a method for controlling the management of a mobile device using a security event, the method including acquiring, by a wireless intrusion prevention server, security threat information by monitoring RF signals generated from an access point (AP) and the mobile device, transmitting the security threat information to a mobile device management server, and executing, by the mobile device management server, a device management policy for the mobile device based on the security threat information.

The security threat information may include at least one of medium access control (MAC) falsification information, unauthorized AP access information, DoS attack information on a certain AP, and inaccessible location information.

When the security threat information is the MAC falsification information, acquiring the security threat information may include extracting an RF fingerprint by analyzing the RF signal that is detected using a sensor from the mobile device accessing a wireless local area network (WLAN), recognizing an actual MAC address of the mobile device by comparing the extracted RF fingerprint and an RF fingerprint registered in a database including MAC identification (ID), discriminating whether there is MAC falsification or not by comparing the actual MAC address with a MAC address inserted in the detected RF signal, and acquiring the security threat information defining the mobile device as a MAC falsification device if it is determined that there is the MAC falsification.

Executing the device management policy may include instructing a mobile device management (MDM) agent embedded in the mobile device to block services based on the security threat information.

When the security threat information is the unauthorized AP access information, acquiring the security threat information may include collecting AP information from a sensor, the AP information being obtained by analyzing the RF signal of the mobile device or the RF signal of the AP, checking whether the AP is an authorized AP or an unauthorized AP by analyzing the AP information, and acquiring the security threat information defining the mobile device as an unauthorized AP access device if the AP is determined to be the unauthorized AP.

Executing the device management policy may include instructing an MDM agent embedded in the mobile device to block the access to the unauthorized AP based on the security threat information.

When the security threat information is the DoS attack information on the certain AP, acquiring the security threat information may include monitoring whether or not the mobile device executes a DoS attack on the certain AP by analyzing the RF signal of the mobile device, and acquiring the security threat information defining the mobile device as a DoS attack device if the DoS attack is detected as a result of the monitoring.

Executing the device management policy may include instructing an MDM agent embedded in the mobile device to block the access to the certain AP or suspend services based on the security threat information.

When the security threat information is the inaccessible location information, acquiring the security threat information may include monitoring whether a current location of the mobile device is an inaccessible location or not by analyzing the RF signal of the mobile device, and acquiring the security threat information defining the mobile device as an inaccessible device if the current location of the mobile device is determined to be the inaccessible location as a result of the monitoring.

Executing the device management policy may include instructing an MDM agent embedded in the mobile device to perform at least one of remote lock processing, camera lock processing, and wireless interface lock processing according to the device management policy based on the security threat information.

In accordance with another aspect of the present invention, there is provided an apparatus for controlling the management of a mobile device using a security event, the apparatus including a wireless intrusion prevention server configured to monitor an RF signal of a mobile device, acquire security threat information including at least one of MAC falsification information, unauthorized AP access information, DoS attack information on a certain AP, and inaccessible location information for the mobile device, and transmit the security threat information to a mobile device management server, and the mobile device management server configured to execute a device management policy for the mobile device based on the security threat information.

When the security threat information is the MAC falsification information, the wireless intrusion prevention server may include an RF fingerprint extraction block configured to extract an RF fingerprint by analyzing the RF signal detected using a sensor from the mobile device that accesses a wireless LAN, a MAC address verification block configured to verify an actual MAC address of the mobile device by checking the extracted RF fingerprint from a database, a MAC falsification discrimination block configured to extract a MAC address inserted in the RF signal, and discriminate whether there is MAC falsification or not by comparing the extracted MAC address with the actual MAC address, and a security threat information generation block configured to generate the security threat information defining the mobile device as a MAC falsification device if it is determined that there is the MAC falsification, and transmit the security threat information to the mobile device management server.

The mobile device management server may be configured to instruct an MDM agent embedded in the mobile device to block services when the security threat information is transmitted thereto.

When the security threat information is the unauthorized AP access information, the wireless intrusion prevention server may include an AP collection block configured to collect AP information from a sensor, the AP information being obtained by analyzing the RF signal of the mobile device or an RF signal of an AP accessed by the mobile device, an AP discrimination block configured to discriminate whether the AP is an authorized AP or an unauthorized AP by analyzing the AP information, and a security threat information generation block configured to generate the security threat information defining the mobile device as an unauthorized AP access device if the AP is determined to be the unauthorized AP and transmit the security threat information to the mobile device management server.

The mobile device management server may be configured to instruct an MDM agent embedded in the mobile device to block the access to the unauthorized AP when the security threat information is transmitted thereto.

When the security threat information is the DoS attack information on the certain AP, the wireless intrusion prevention server may include an RF collection block configured to collect the RF signal detected from the mobile device, a DoS attack detection block configured to monitor whether or not the mobile device executes a DoS attack on the certain AP by analyzing the collected RF signal, and a security threat information generation block configured to generate the security threat information defining the mobile device as a DoS attack device if the DoS attack is detected as a result of the monitoring, and transmit the security threat information to the mobile device management server.

When the security threat information is the inaccessible location information, the security intrusion prevention server may include an RF collection block configured to collect the RF signal detected from the mobile device, a location determination block configured to monitor whether a current location of the mobile device is an inaccessible location or not by analyzing the collected RF signal, and a security threat information generation block configured to generate the security threat information defining the mobile device as an inaccessible device if the current location of the mobile device is determined to be the inaccessible location as a result of the monitoring, and transmit the security threat information to the mobile device management server.

In accordance with an aspect of the present invention, there is provided a method for controlling the management of a mobile device using a security event, the method including securing, by a mobile device management server, dangerous state information of the mobile device from an MDM agent embedded in the mobile device, transmitting the dangerous state information to a wireless intrusion prevention server, and executing, by the wireless intrusion prevention server, a device management policy for the wireless intrusion prevention based on the dangerous state information.

The dangerous state information may include any of jailbreak or rooting information of the mobile device and forced deletion information of the MDM agent.

The jailbreak or rooting information may be generated when the MDM agent detects a state change of the mobile device and transmitted to the mobile device management server, and the forced deletion information may be automatically generated when communications between the mobile device management server and the MDM agent is cut off for a predetermined time.

The dangerous state information may further include loss information of the mobile device provided from a user.

In accordance with the embodiments of the present invention, it is possible to effectively enhance the security for a wireless LAN service of the mobile device by securing security threat information from the mobile device by monitoring the RF signal through the wireless intrusion prevention server, transmitting the security threat information to the mobile device management server, instructing the mobile device management server to execute a device management policy for the mobile device based on the security threat information.

### BRIEF DESCRIPTION OF THE DRAWINGS

The above and other objects and features of the present invention will become apparent from the following description of embodiments given in conjunction with the accompanying drawings, in which:

FIG. 1 is a schematic diagram for illustrating a mobile device management control system in accordance with an embodiment of the present invention;

FIG. 2 illustrates a block diagram of a wireless intrusion prevention server in accordance with a first embodiment of the present invention;

FIG. 3 is a flowchart illustrating processes for providing a mobile device management control service by detecting MAC falsification in accordance with the first embodiment of the present invention;

FIG. 4 illustrates a block diagram of a wireless intrusion prevention server in accordance with a second embodiment of the present invention;

FIG. 5 is a flowchart illustrating processes for providing a mobile device management control service by detecting access to an unauthorized AP in accordance with the second embodiment of the present invention;

FIG. 6 illustrates a block diagram of a wireless intrusion prevention server in accordance with a third embodiment of the present invention;

FIG. 7 is a flowchart illustrating processes for providing a mobile device management control service by detecting a DoS attack on a certain AP in accordance with the third embodiment of the present invention;

FIG. 8 illustrates a block diagram of a wireless intrusion prevention server in accordance with a fourth embodiment of the present invention;

FIG. 9 is a flowchart illustrating processes for providing a mobile device management control service by detecting an inaccessible location in accordance with the fourth embodiment of the present invention; and

FIG. 10 is a flowchart illustrating processes for providing a mobile device management control service for a mobile device based on dangerous state information of the mobile device in accordance with a fifth embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Hereinafter, embodiments of the present invention will be described in detail with reference to the accompanying drawings so that they can be readily implemented by those skilled in the art.

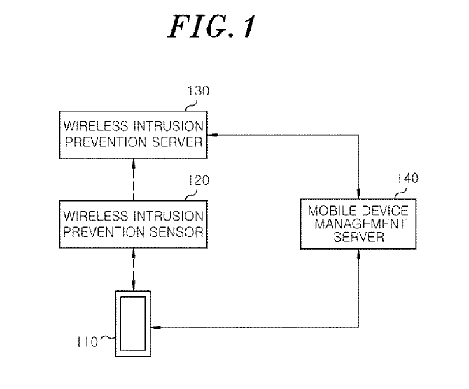

FIG. 1 is a schematic diagram illustrating a mobile device management control system in accordance with an embodiment of the present invention, which includes a mobile device 110, a wireless intrusion prevention sensor 120, a wireless intrusion prevention server 130, and a mobile device management (MDM) server 140.

Referring to FIG. 1, the mobile device 110 may be a mobile terminal used by a user who would like to receive a mobile device management control service provided according to an embodiment of the present invention. The mobile terminal may include a mobile phone, a smart phone, a smart pad, a note pad, a tablet PC, and so on. The mobile device 110 may be provided with a wireless local area network (WLAN) service by accessing an access point (AP) using its MAC address. In accordance with an embodiment of the present invention, the mobile device management control service may be provided according to a device management policy. The MDM server 140 executes the device management policy based on security threat information that includes at least one of MAC falsification information, unauthorized AP access information, DoS attack information on a certain AP, and inaccessible location information.

The mobile device 110 may execute service blocking, access blocking to an unauthorized AP, access blocking to a certain AP, remote lock processing, camera lock processing, and wireless interface lock processing in response to service instructions according to the device management policy provided by the MDM server 140. For this purpose, the mobile device 110 may include a WLAN receiver (or a Wi-Fi receiver) and an MDM agent.

The MDM agent embedded in the mobile device 110 may generate dangerous state information when it detects a state change of the mobile device 110 such as jailbreak or rooting, and transmit the dangerous state information to the MDM server 140.

The wireless intrusion prevention sensor 120 may include a sensor located around the mobile device 110. The wireless intrusion prevention sensor 120 may detect or secure an RF signal of the mobile device 110 when the mobile device 110 accesses thereto through an AP, and transfer the RF signal to the wireless intrusion prevention server 130. The RF signal, which is transferred to the wireless intrusion prevention server 130, may include MAC address information of the mobile device 110. The wireless intrusion prevention sensor 120 may be implemented as a stand-alone (or independent) sensor or an all-in-one (or integral) sensor that is embedded in an AP.

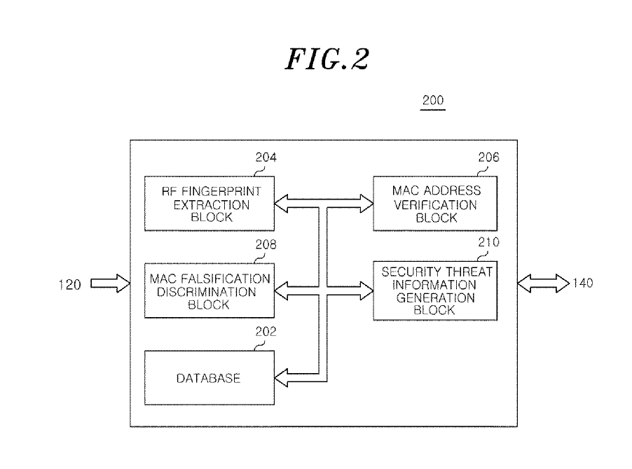

The wireless intrusion prevention server 130 may monitor the RF signal collected from the wireless intrusion prevention sensor 120, secure security threat information, which includes at least one of MAC falsification information, unauthorized AP access information, DoS attack information on a certain AP, and inaccessible location information, from the mobile device 110, and transmit the security threat information to the MDM server 140. For this purpose, the wireless intrusion prevention server 130 may include configurations illustrated in FIGS. 2, 3, 6, and 8, respectively. Detailed functions of components constituting the wireless intrusion prevention server 130 will be described later with reference to FIGS. 2 to 9.

Herein, the wireless intrusion prevention sensor 120 and the wireless intrusion prevention server 130 may be called a wireless intrusion prevention system for providing each mobile device with a WLAN related control service such as a security event related control service.

The MDM sever 140 may execute the device management policy, e.g., a self-management policy, for the wireless intrusion prevention when the dangerous state information of the mobile device 110 is provided thereto from the wireless intrusion prevention server 130. That is, the MDM sever 140 may provide a management control service such as a service of blocking access of the mobile device 110 to an AP that is managed by the wireless intrusion prevention server 130.

Herein, the dangerous state information of the mobile device 110 may include at least one of jailbreak or rooting information of the mobile device 110, forced deletion information of the MDM agent, and loss information of the mobile device 110.

The MDM server 140 may remotely manage various services that the mobile device 110 requires. The various services may include device management (e.g., automatically updating a firmware of the mobile device), registration for use and tracking management, registration/authentication/recovery for the mobile device 110, withdrawal of the use of the mobile device 110 when the mobile device 110 is lost or stolen (e.g., data deletion/lock of the mobile device 110), software distribution through the MDM server 140, remote diagnosis and after service (AS) for the mobile device 110, and so on. In accordance with an embodiment, the MDM server 140 may provide a service of executing the device management policy for the mobile device 110 based on the security threat information provided from the wireless intrusion prevention server 130.

The MDM server 140 may instruct the MDM agent embedded in the mobile device 110 to execute access blocking to an unauthorized AP, access blocking to a certain AP, remote lock processing, camera lock processing, wireless interface lock processing, and so on, when services are blocked, according to the device management policy.

The MDM server 140 may also secure the dangerous state information (e.g., jailbreak or rooting information, and forced deletion information) of the mobile device 110 from the MDM agent embedded in the mobile device 110. Or, the MDM server 140 may transmit the dangerous state information to the wireless intrusion prevention server 130 when it obtains the dangerous state information, e.g., loss information of the mobile device 110, from a user.

Herein, the jailbreak or rooting information represents dangerous state information that is generated when the state change of the mobile device 110 is detected by the MDM agent and that is transmitted to the MDM server 140. The forced deletion information represents information that the MDM server 140 automatically generates when communications between the MDM server 140 and the MDM agent is cut off for a predetermined time.

### First Embodiment

FIG. 2 illustrates a block diagram of a wireless intrusion prevention server 200 in accordance with a first embodiment of the present invention, which includes a database 202, an RF fingerprint extraction block 204, a MAC address verification block 206, a MAC falsification discrimination block 208, and a security threat information generation block 210.

Referring to FIG. 2, the database 202 may store MAC address information (list) and registered RF fingerprint information related to each mobile device for which the mobile device management control service is registered. These information may be provided from the MDM server 140 of FIG. 1 or other external servers that provide similar related services and stored in the database 202.

The RF fingerprint extraction block 204 may collect and analyze an RF signal (RF information) detected from the mobile device 110, which accesses a WLAN, through a sensor, i.e., the wireless intrusion prevention sensor 120, and extracting an RF fingerprint from the analyzed result. For this purpose, the RF fingerprint extraction block 204 may include an identification engine for mobile device identification.

The MAC address verification block 206 may compare the RF fingerprint extracted by the RF fingerprint extraction block 204 with an RF fingerprint of each mobile device registered in the database 202, which stores the MAC address information, so at to verify or recognize an actual MAC address of the mobile device 110.

The MAC falsification discrimination block 208 may extract a MAC address inserted in the RF signal collected by the wireless intrusion prevention sensor 120 and compare the extracted MAC address with the actual MAC address verified by the MAC address verification block 206, thereby discriminating whether the MAC address of the mobile device 110 is falsified or not.

The security threat information generation block 210 may generate security threat information defining the mobile device 110 as a mobile device whose MAC address is falsified when the discrimination result for the MAC falsification is transferred from the MAC falsification discrimination block 208, and transmit the security threat information to the MDM server 140.

Hereinafter, a sequence of processes for providing a mobile device management control service by detecting the MAC falsification using the mobile device management control system that has the configuration illustrated in FIG. 2 will be described in detail.

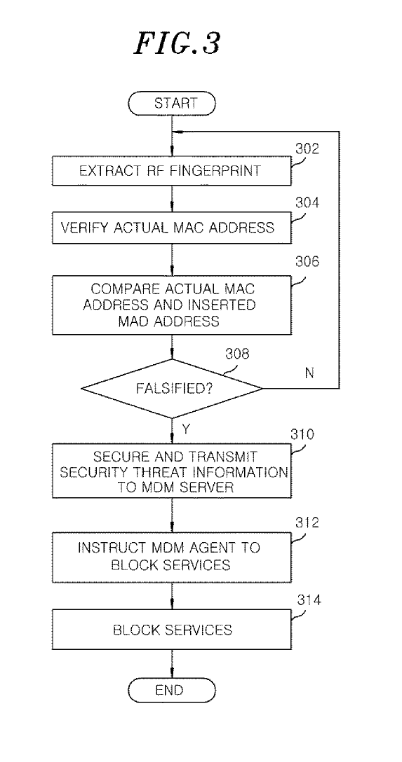

FIG. 3 is a flowchart illustrating the processes for providing the mobile device management control service by detecting the MAC falsification in accordance with the first embodiment of the present invention.

Referring to FIG. 3, the wireless intrusion prevention sensor 120 detects an RF signal of a mobile device, e.g., the mobile device 110, when the mobile device 110 accesses thereto through a certain AP, and transfers the RF signal to the wireless intrusion prevention server 130. In response thereto, the RF fingerprint extraction block 204 in the wireless intrusion prevention server 130 analyzes the RF signal (RF information) collected (detected) by the wireless intrusion prevention sensor 120 and extracts an RF fingerprint of the mobile device 110 in step 302. The extracted RF fingerprint is transferred to the MAC address verification block 206.

After that, the MAC address verification block 206 compares the RF fingerprint transferred from the RF fingerprint extraction block 204 with an RF fingerprint of each mobile device that is registered in the database 202 where MAC address information is stored, and verifies an actual MAC address of the mobile device 110 based on the RF fingerprint comparison result in step 304. For this purpose, a MAC address list for each mobile device is pre-stored in the database 202. The MAC address list may be provided from the MDM server 140 of FIG. 1.

The MAC falsification discrimination block 208 extracts a MAC address inserted in the RF signal collected from the wireless intrusion prevention sensor 120 and compares the extracted MAC address with the actual MAC address verified by the MAC address verification block 206 in step 306. After that, the MAC falsification discrimination block 208 determines whether the MAC address of the mobile device 110 is a falsified MAC address or not based on the MAC address comparison result in step 308.

As a result of the discrimination obtained in step 308, if the MAC address of the mobile device 110 is determined as the falsified MAC address, the security threat information generation block 210 generates security threat information defining the mobile device 110 as a MAC falsified mobile device and transmits the security threat information to the MDM server 140. The security threat information transmitted to the MDM server 140 may include the actual MAC address and the MAC address inserted in the RF signal.

Herein, as the security threat information generation block 210 generates the security threat information defining the mobile device 110 as the MAC falsified mobile device and transmits the security threat information to the MDM server 140, the MDM server 140 can share the security threat information obtained based on the collected RF signal with the wireless intrusion prevention server 130.

In response, the MDM server 140 executes a mobile device management polity for the mobile device 110 based on the security threat information provided from the wireless intrusion prevention server 130. That is, the MDM server 140 generates an instruction for blocking a WLAN access service, i.e., a service blocking instruction message, and transmits the instruction to the MDM agent embedded in the mobile device 110 in step 312.

As a result, the MDM agent embedded in the mobile device 110 executes the service blocking, and thus the WLAN access service of the mobile device 110 is automatically blocked in step 314.

### Second Embodiment

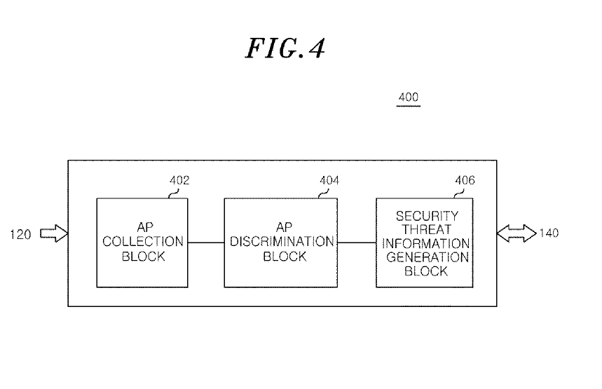

FIG. 4 illustrates a block diagram of a wireless intrusion prevention server 400 in accordance with a second embodiment of the present invention, which includes an AP collection block 402, an AP discrimination block 404, and a security threat information generation block 406.

Referring to FIG. 4, the AP collection block 402 may collect AP information, i.e., information on an AP that a mobile device, e.g., the mobile device 110, accesses, by collecting and analyzing an RF signal (RF information) of the AP or an RF signal (RF information) of the mobile device 110 that accesses a WLAN, the RF signal (RF information) being obtained from the wireless intrusion prevention sensor 120. At this time, the AP information collected from the wireless intrusion prevention sensor 120 may include device identification (ID) of the mobile device 110 and MAC or SSID information of the AP.

The AP discrimination block 404 may analyze the collected AP information, that is, check whether a MAC address of the AP exists in a white list or not, and discriminate whether the AP is an authorized AP or an unauthorized AP.

For this purpose, the white list including MAC address information for each AP is stored in a database (not shown), and the white list may be provided from the MDM server 140 shown in FIG. 1.

Finally, the security threat information generation block 406 may generate security threat information defining the mobile device 110 as a mobile device that accesses the unauthorized AP when the discrimination result showing that the AP is the unauthorized AP is provided thereto, and transmit the security threat information to the MDM server 140.

Hereinafter, a sequence of processes for providing a mobile device management control service by detecting access to the unauthorized AP using the mobile device management control system having the configuration illustrated in FIG. 4 will be described in detail.

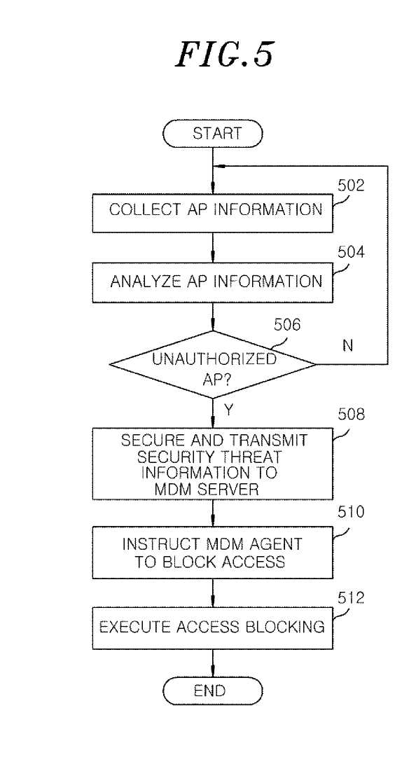

FIG. 5 is a flowchart illustrating processes for providing the mobile device management control service by detecting access to the unauthorized AP in accordance with the second embodiment of the present invention.

Referring to FIG. 5, the wireless intrusion prevention sensor 120 collects and analyzes an RF signal of a certain AP or an RF signal of a mobile device, e.g., the mobile device 110, when the mobile device 110 accesses thereto through the certain AP to thereby acquire AP information of the specific AP, and transmits the AP information to the wireless intrusion prevention server 130 in step 502. In response, the AP collection block 402 in the wireless intrusion prevention server 130 transmits the collected AP information to the AP discrimination block 404. Herein, the AP information may include device identification (ID) of the mobile device 110 and MAC or SSID information of the certain AP.

Subsequently, the AP discrimination block 404 analyzes the collected AP information provided from the AP collection block 402, that is, checks whether a MAC address of the certain AP exists in a white list stored in a database (not shown) or not in step 504, and discriminates whether the certain AP is an authorized AP or an unauthorized AP based on the check result in step 506. Herein, the white list including MAC address information for each AP and stored in the database may be provided from the MDM server 140 shown in FIG. 1.

As the discrimination result obtained in the step 506, if the certain AP is determined to be the unauthorized AP, the security threat information generation block 406 generates security threat information defining the mobile device 110 as a mobile device accessing the unauthorized AP, and transmits the security threat information to the MDM server 140 shown in FIG. 1 in step 508.

Herein, as the security threat information generation block 404 generates the security threat information defining the mobile device 110 as the mobile device accessing the unauthorized AP and transmits the security threat information to the MDM server 140, the MDM server 140 can share the security threat information obtained based on the collected RF signal with the wireless intrusion prevention server 130.

In response, the MDM server 140 executes a device management policy for the mobile device 110 based on the security threat information provided from the wireless intrusion prevention server 130. That is, the MDM server 140 generates and transmits an instruction for blocking the access to the unauthorized AP, i.e., an AP access blocking instruction message, to then MDM agent embedded in the mobile device 110 in step 510.

As a result, the MDM agent embedded in the mobile device 110 performs the AP access blocking, so that the access of the mobile device 110 to the certain AP is automatically blocked in step 512.

### Third Embodiment

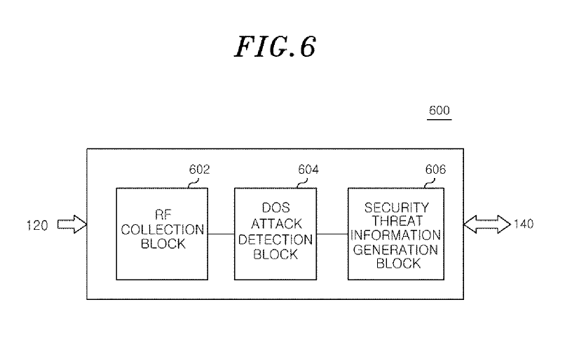

FIG. 6 illustrates a block diagram of a wireless intrusion prevention server 600 in accordance with a third embodiment of the present invention, which includes an RF collection block 602, a DoS attack detection block 604, and a security threat information generation block 606.

Referring to FIG. 6, the RF collection block 602 may collect an RF signal of a mobile device, e.g., the mobile device 110, accessing a WLAN provided by the wireless intrusion prevention sensor 120.

After that, the DoS attack detection block 604 may analyze the RF signal collected by the RF collection block 602 to monitor whether the mobile device 110 does DoS attack a certain AP or not. For instance, when the mobile device 110 repeatedly transmits a specific control signal to the certain AP, the DoS attack detection block 604 may detect it that the mobile device 110 does DoS attack the certain AP.

The security threat information generation block 606 may generate security threat information defining the mobile device 110 as a DoS attack mobile device when it receives a result of detecting the DoS attack on the certain AP from the DoS attack detection block 604, and transmit the security threat information to the MDM server 140.

Hereinafter, a sequence of processes for providing a mobile device management control service by detecting the DoS attack on the certain AP using the mobile device management control system having the configuration illustrated in FIG. 6 will be described in detail.

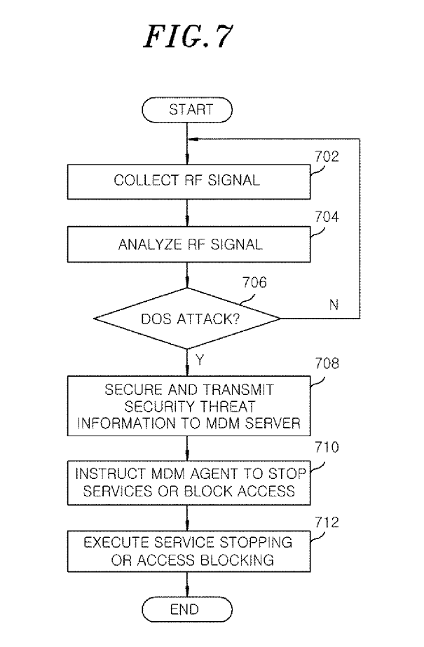

FIG. 7 is a flowchart illustrating processes for providing the mobile device management control service by detecting the DoS attack on the certain AP in accordance with the third embodiment of the present invention.

Referring to FIG. 7, the wireless intrusion prevention sensor 120 secures an RF signal of a mobile device, e.g., the mobile device 110, when the mobile device 110 accesses thereto through a certain AP, and transmits the RF signal to the wireless intrusion prevention server 130 in step 702. In response, the RF collection block 602 in the wireless intrusion prevention server 130 collects the RF signal of the mobile device 110 and transfers the RF signal to the DoS attack detection block 604.

After that, the DoS attack detection block 604 analyzes the RF signal provided from the RF collection block 602 in step 704, and determines whether the mobile device 110 executes a DoS attack on the certain AP or not based on the analyzed result in step 706. Herein, when the mobile device 110 repeatedly sends a specific control signal to the certain AP, the DoS attack detection block 604 may detect it as the DoS attack on the certain AP.

As a result of the determination result obtained in the step 706, if the mobile device 110 is determined to be a mobile device executing the DoS attack on the certain AP, the security threat information generation block 606 generates security threat information defining the mobile device 110 as the DoS attack mobile device and transmits the security threat information to the MDM server 140 in step 708.

Herein, as the security threat information generation block 606 generates the security threat information defining the mobile device 110 as the DoS attack mobile device and transmits the security threat information to the MDM server 140, the MDM server 140 can share the security threat information obtained based on the collected RF signal with the wireless intrusion prevention server 130.

In response, the MDM server 140 executes a device management policy for the mobile device 110 based on the security threat information provided from the wireless intrusion prevention server 130. That is, the MDM server 140 generates and transmits an instruction for suspending a service or blocking the access to the unauthorized AP, i.e., an AP access blocking instruction message, to the MDM agent embedded in the mobile device 110 in step 710.

As a result, the MDM agent embedded in the mobile device 110 performs the service suspending or the AP access blocking, so that the access of the mobile device 110 to the certain AP is automatically blocked or the service providing is suspended in step 712.

### Fourth Embodiment

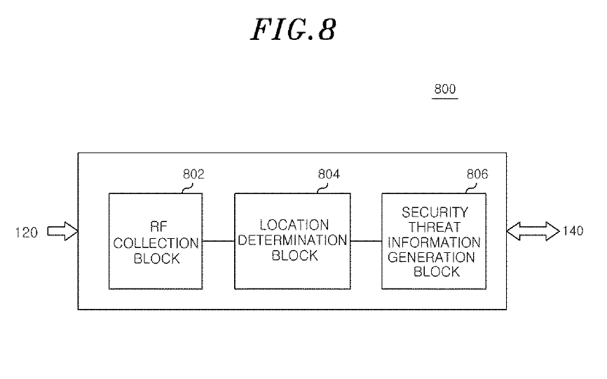

FIG. 8 illustrates a block diagram of a wireless intrusion prevention server 800 in accordance with a fourth embodiment of the present invention, which includes an RF collection block 802, a location determination block 804, and a security threat information generation block 806.

Referring to FIG. 8, the RF collection block 802 may collect an RF signal of a mobile device, e.g., the mobile device 110, accessing a WLAN provided by the wireless intrusion prevention sensor 120.

After that, the location determination block 804 may analyze the RF signal collected by the RF collection block 802 to monitor whether a current location of the mobile device 110 is a predetermined inaccessible location or not.

For this purpose, a database (not shown) pre-stores information on a predetermined inaccessible location, e.g., a conference room 555 of a building A, for each mobile device. This information may be provided from the MDM server 140 shown in FIG. 1 or other external servers.

Finally, the security threat information generation block 806 may generate security threat information defining the mobile device 110 as an inaccessible mobile device when a determination result of showing that the current location of the mobile device 110 is the predetermined inaccessible location is transmitted thereto from the location determination block 804, and transmit the security threat information to the MDM server 140.

Hereinafter, a sequence of processes for providing a mobile device management control service by detecting the inaccessible location using the mobile device management control system having the configuration illustrated in FIG. 8 will be described in detail.

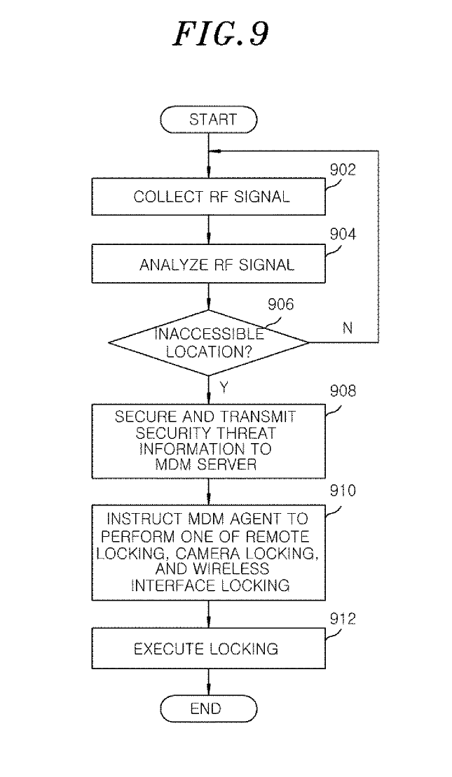

FIG. 9 is a flowchart illustrating processes for providing the mobile device management control service by detecting the inaccessible location in accordance with the fourth embodiment of the present invention.

Referring to FIG. 9, the wireless intrusion prevention sensor 120 secures an RF signal of a mobile device, e.g., the mobile device 110, when the mobile device 110 accesses thereto through a certain AP, and transmits the RF signal to the wireless intrusion prevention server 130 in step 902. In response, the RF collection block 802 in the wireless intrusion prevention server 130 collects the RF signal of the mobile device 110 and transfers the RF signal to the location determination block 804.

After that, the location determination block 804 analyzes the RF signal provided from the RF collection block 802 in step 904, and determines whether the current location of the mobile device 110 is the predetermined inaccessible location or not based on the analyzed result in step 906.

As a result of the determination result obtained in the step 906, if the current location of the mobile device 110 is determined to be the predetermined inaccessible location, the security threat information generation block 806 generates security threat information defining the mobile device 110 as the inaccessible mobile device and transmits the security threat information to the MDM server 140 shown in FIG. 1 in step 908.

Herein, as the security threat information generation block 806 generates the security threat information defining the mobile device 110 as the inaccessible mobile device and transmits the security threat information to the MDM server 140, the MDM server 140 can share the security threat information obtained based on the collected RF signal with the wireless intrusion prevention server 130.

In response, the MDM server 140 executes a device management policy for the mobile device 110 based on the security threat information provided from the wireless intrusion prevention server 130. That is, the MDM server 140 generates and transmits an instruction for executing any one of remote lock processing, camera lock processing, and wireless interface lock processing to the MDM agent embedded in the mobile device 110 in step 910.

As a result, the MDM agent embedded in the mobile device 110 performs any one of the remote lock processing, the camera lock processing, and the wireless interface lock processing, so that the mobile device 110 transitions to a state of one of the remote lock processing, the camera lock processing, and the wireless interface lock processing in step 912.

### Fifth Embodiment

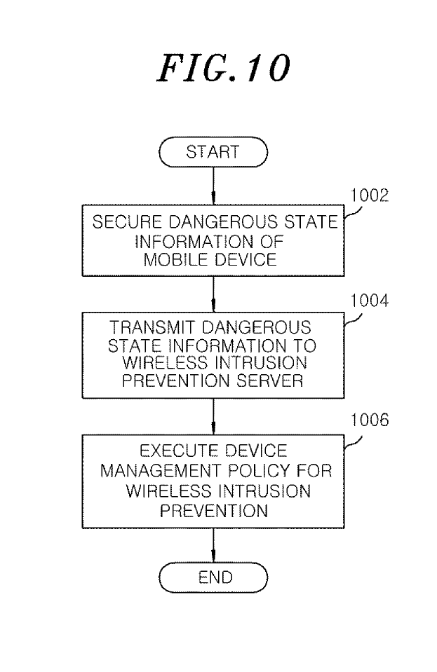

FIG. 10 is a flowchart illustrating processes for providing a mobile device management control service based on dangerous state information of a mobile device in accordance with a fifth embodiment of the present invention.

First of all, while the first to fourth embodiments in which the wireless intrusion prevention server 130 provides information to be shared to the MDM server 140, in accordance with the fifth embodiment, the MDM server 140 provides the information to be shared to the wireless intrusion prevention server 130.

Referring to FIG. 10, in step 1002, the MDM server 140 acquires dangerous state information of the mobile device 110, e.g., jailbreak or rooting information, and forced deletion information, from the MDM agent embedded in the mobile device 110, or the MDM server 140 obtains dangerous state information, e.g., loss information of the mobile device 110, from a user.

Herein, the jailbreak or rooting information represents dangerous state information that is generated when the state change of the mobile device 110 is detected by the MDM agent and that is transmitted to the MDM server 140 by the MDM agent. The forced deletion information represents information that is automatically generated at the MDM server 140 when communications between the MDM server 140 and the MDM agent is cut off for a predetermined time.

After that, the MDM server 140 transmits the dangerous state information to the wireless intrusion prevention server 130 in step 1004. Here, the transmission of the dangerous state information may be set to be executed in real time when the dangerous state information is generated.

Subsequently, the wireless intrusion prevention server 130 executes a device management policy, e.g., a self-management policy, for the wireless intrusion prevention when the dangerous state information of the mobile device 110 is provided from the MDM server 140. For instance, the wireless intrusion prevention server 130 performs an AP access blocking policy to prevent the mobile device 110 from accessing APs being managed by the wireless intrusion prevention server 130 in step 1006.

Meanwhile, combinations of each block of the accompanying block diagram and each step of the accompanying flowchart may be performed by computer program instructions. These computer program instructions may be loaded on a processor of a general-purpose computer, a special-purpose computer, or other programmable data processing equipments. Therefore, the instructions performed by the processor of the computers or other programmable data processing equipments generate units for performing functions explained in each step of the flowchart or each block of the block diagram. Since the computer program instructions can be stored in a computer usable memory or a computer readable memory to be employed in a computer or other programmable data processing equipments to implement functions of the instructions in a specific manner, the instructions stored in the computer usable memory or the computer readable memory can be manufactured as products employing an instruction unit for performing functions explained in each step of the flowchart or each block of the block diagram. Since the computer program instructions can be loaded on the computer or other programmable data processing equipments, a sequence of operating steps is performed on the computer or other programmable data processing equipments to generate a process performed by the computer. Therefore, the instructions processed by the computer or other programmable data processing equipments can provide steps of performing the functions explained in each step of the flowchart and each block of the block diagram.

In addition, each block or each step may represent a part of a module, a segment, or a code including at least one executable instruction for performing specific logical function(s). In accordance with other embodiments, it is noted that the functions mentions in the blocks or steps can be performed regardless of their order. For instance, two blocks or steps illustrated sequentially can be simultaneously performed or the blocks or steps can be performed in reverse order according to their functions.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. A method for controlling the management of a mobile device using a security event, the method comprising:
acquiring, by a wireless intrusion prevention server, security threat information by monitoring RF signals generated from an access point (AP) and the mobile device;
transmitting the security threat information to a mobile device management server; and
executing, by the mobile device management server, a device management policy for the mobile device based on the security threat information.

2. The method of claim 1, wherein the security threat information comprises at least one of medium access control (MAC) falsification information, unauthorized AP access information, DoS attack information on a certain AP, and inaccessible location information.

3. The method of claim 2, wherein, when the security threat information is the MAC falsification information, acquiring the security threat information comprises:
extracting an RF fingerprint by analyzing the RF signal that is detected using a sensor from the mobile device accessing a wireless local area network (WLAN);
recognizing an actual MAC address of the mobile device by comparing the extracted RF fingerprint and an RF fingerprint registered in a database including MAC identification (ID);
discriminating whether there is MAC falsification or not by comparing the actual MAC address with a MAC address inserted in the detected RF signal; and
acquiring the security threat information defining the mobile device as a MAC falsification device if it is determined that there is the MAC falsification.

4. The method of claim 3, wherein executing the device management policy comprises instructing a mobile device management (MDM) agent embedded in the mobile device to block services based on the security threat information.

5. The method of claim 2, wherein, when the security threat information is the unauthorized AP access information, acquiring the security threat information comprises:
collecting AP information from a sensor, the AP information being obtained by analyzing the RF signal of the mobile device or the RF signal of the AP;
checking whether the AP is an authorized AP or an unauthorized AP by analyzing the AP information; and
acquiring the security threat information defining the mobile device as an unauthorized AP access device if the AP is determined to be the unauthorized AP.

6. The method of claim 5, wherein executing the device management policy comprises instructing an MDM agent embedded in the mobile device to block the access to the unauthorized AP based on the security threat information.

7. The method of claim 2, wherein, when the security threat information is the DoS attack information on the certain AP, acquiring the security threat information comprises:
monitoring whether or not the mobile device executes a DoS attack on the certain AP by analyzing the RF signal of the mobile device; and
acquiring the security threat information defining the mobile device as a DoS attack device if the DoS attack is detected as a result of the monitoring.

8. The method of claim 7, wherein executing the device management policy comprises instructing an MDM agent embedded in the mobile device to block the access to the certain AP or suspend services based on the security threat information.

9. The method of claim 2, wherein, when the security threat information is the inaccessible location information, acquiring the security threat information comprises:
monitoring whether a current location of the mobile device is an inaccessible location or not by analyzing the RF signal of the mobile device; and
acquiring the security threat information defining the mobile device as an inaccessible device if the current location of the mobile device is determined to be the inaccessible location as a result of the monitoring.

10. The method of claim 9, wherein executing the device management policy comprises instructing an MDM agent embedded in the mobile device to perform at least one of remote lock processing, camera lock processing, and wireless interface lock processing according to the device management policy based on the security threat information.

11. An apparatus for controlling the management of a mobile device using a security event, the apparatus comprising:
a wireless intrusion prevention server configured to monitor an RF signal of a mobile device, acquire security threat information including at least one of MAC falsification information, unauthorized AP access information, DoS attack information on a certain AP, and inaccessible location information for the mobile device, and transmit the security threat information to a mobile device management server; and
the mobile device management server configured to execute a device management policy for the mobile device based on the security threat information.

12. The apparatus of claim 11, wherein, when the security threat information is the MAC falsification information, the wireless intrusion prevention server comprises:
an RF fingerprint extraction block configured to extract an RF fingerprint by analyzing the RF signal detected using a sensor from the mobile device that accesses a wireless LAN;
a MAC address verification block configured to verify an actual MAC address of the mobile device by checking the extracted RF fingerprint from a database;
a MAC falsification discrimination block configured to extract a MAC address inserted in the RF signal, and discriminate whether there is MAC falsification or not by comparing the extracted MAC address with the actual MAC address; and
a security threat information generation block configured to generate the security threat information defining the mobile device as a MAC falsification device if it is determined that there is the MAC falsification, and transmit the security threat information to the mobile device management server.

13. The apparatus of claim 12, wherein the mobile device management server is configured to instruct an MDM agent embedded in the mobile device to block services when the security threat information is transmitted thereto.

14. The apparatus of claim 11, wherein, when the security threat information is the unauthorized AP access information, the wireless intrusion prevention server comprises:
an AP collection block configured to collect AP information from a sensor, the AP information being obtained by analyzing the RF signal of the mobile device or an RF signal of an AP accessed by the mobile device;
an AP discrimination block configured to discriminate whether the AP is an authorized AP or an unauthorized AP by analyzing the AP information; and
a security threat information generation block configured to generate the security threat information defining the mobile device as an unauthorized AP access device if the AP is determined to be the unauthorized AP and transmit the security threat information to the mobile device management server.

15. The apparatus of claim 14, wherein the mobile device management server is configured to instruct an MDM agent embedded in the mobile device to block the access to the unauthorized AP when the security threat information is transmitted thereto.

16. The apparatus of claim 11, wherein, when the security threat information is the DoS attack information on the certain AP, the wireless intrusion prevention server comprises:
an RF collection block configured to collect the RF signal detected from the mobile device;
a DoS attack detection block configured to monitor whether or not the mobile device executes a DoS attack on the certain AP by analyzing the collected RF signal; and
a security threat information generation block configured to generate the security threat information defining the mobile device as a DoS attack device if the DoS attack is detected as a result of the monitoring, and transmit the security threat information to the mobile device management server.

17. The apparatus of claim 11, wherein, when the security threat information is the inaccessible location information, the security intrusion prevention server comprises:
an RF collection block configured to collect the RF signal detected from the mobile device;
a location determination block configured to monitor whether a current location of the mobile device is an inaccessible location or not by analyzing the collected RF signal; and
a security threat information generation block configured to generate the security threat information defining the mobile device as an inaccessible device if the current location of the mobile device is determined to be the inaccessible location as a result of the monitoring, and transmit the security threat information to the mobile device management server.

18. A method for controlling the management of a mobile device using a security event, the method comprising:
securing, by a mobile device management server, dangerous state information of the mobile device from an MDM agent embedded in the mobile device;
transmitting the dangerous state information to a wireless intrusion prevention server; and
executing, by the wireless intrusion prevention server, a device management policy for the wireless intrusion prevention based on the dangerous state information.

19. The method of claim 18, wherein the dangerous state information comprises any of jailbreak or rooting information of the mobile device and forced deletion information of the MDM agent.

20. The method of claim 19, wherein the jailbreak or rooting information is generated when the MDM agent detects a state change of the mobile device and transmitted to the mobile device management server, and
wherein the forced deletion information is automatically generated when communications between the mobile device management server and the MDM agent is cut off for a predetermined time.
